(19) United States
(12) Patent Application Publication
(10) Pub. No.: US 2024/0428328 A1
(43) Pub. Date: Dec. 26, 2024

(54) MACHINE LEARNING OPTIMIZATION OF MULTIPLE STOCK PORTFOLIOS CLOSEOUT

(71) Applicant: International Business Machines Corporation, Armonk, NY (US)

(72) Inventors: Ana Paula Appel, Sâo Paulo (BR); Carlos Lessandro Lopes Rischioto, São Paulo (BR); Jeferson Aparecido Moia, Sao Bernardo do Campo (BR); Pablo Roberto Millicay Gonzalez, São Paulo (BR); Rogerio Cesar Barbosa dos Santos da Silva, São Paulo (BR)

(21) Appl. No.: 18/213,664

(22) Filed: Jun. 23, 2023

(51) Int. Cl. G06Q 40/04

(52) U.S. Cl. CPC G06Q 40/04

(57) ABSTRACT

One embodiment provides a method of using a computing device to analyze and generate a portfolio action strategy for clients including receiving a portfolio with stock information on one or more stocks held in the portfolio. The computing device receives a guideline for actions for the one or more stocks in the portfolio. The computing device further receives a historical set of data for a plurality of stocks. The computing device additionally trains a machine learning model that combines, analyzes and clusters stocks in the plurality of stocks by volatility, segment, stability, and volume. The computing device receives a current state of the one or more stocks held in the portfolio. The computing device further analyzes, utilizing the trained machine learning model, the stock information and a current state of the one or more stocks held in the portfolio to create a portfolio action strategy for the portfolio.

### BACKGROUND

The field of embodiments of the present invention relates to using machine learning for optimization of multiple stock portfolios closeout.

Financial institutions face a problem when they closeout a portfolio of stocks when the client becomes a defaulter. With people adhering to the stock market and the financial market becoming more competitive, being capable to minimize loss in day-by-day operations is a differentiator. To closeout a portfolio of stocks, financial institutions follow a procedure that can be either manual or automated, but in either case the procedure is unique to each client.

### SUMMARY

Embodiments relate to using machine learning for optimization of multiple stock portfolios closeout. One embodiment provides a method of using a computing device to analyze and generate a portfolio action strategy for clients including receiving, by the computing device, a portfolio with stock information on one or more stocks held in the portfolio. The computing device receives a guideline for actions for the one or more stocks in the portfolio. The computing device further receives a historical set of data for a plurality of stocks. The computing device additionally trains a machine learning model that combines, analyzes and clusters stocks in the plurality of stocks by volatility, segment, stability, and volume. The computing device further receives a current state of the one or more stocks held in the portfolio. The computing device further analyzes, utilizing the trained machine learning model, the stock information and a current state of the one or more stocks held in the portfolio to create a portfolio action strategy for the portfolio.

These and other features, aspects and advantages of the present embodiments will become understood with reference to the following description, appended claims and accompanying figures.

### BRIEF DESCRIPTION OF THE DRAWINGS

FIG. 1 illustrates an architecture for using machine learning for optimization of multiple stock portfolios closeout, according to one embodiment;

FIG. 2 illustrates a flow processing diagram for using machine learning for optimization of multiple stock portfolios closeout, according to one embodiment;

FIG. 3 illustrates an example embodiment for using machine learning for optimization of multiple stock portfolios closeout, according to one embodiment;

FIG. 4 illustrates a process for using a computing device to analyze and generate a portfolio action strategy for clients, according to an embodiment; and

FIG. 5 illustrates an example computing environment utilized by one or more embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to using machine learning for optimization of multiple stock portfolios closeout. One embodiment provides a method of using a computing device to analyze and generate a portfolio action strategy for clients including receiving, by the computing device, a portfolio with stock information on one or more stocks held in the portfolio. The computing device receives a guideline for actions for the one or more stocks in the portfolio. The computing device further receives a historical set of data for a plurality of stocks. The computing device additionally trains a machine learning model that combines, analyzes and clusters stocks in the plurality of stocks by volatility, segment, stability, and volume. The computing device further receives a current state of the one or more stocks held in the portfolio. The computing device further analyzes, utilizing the trained machine learning model, the stock information and a current state of the one or more stocks held in the portfolio to create a portfolio action strategy for the portfolio.

Stock portfolios closeout, due to client default, is often a problem to brokerage demanding an efficient risk management of their clients and themselves. As for the brokerage, they need to execute the settlement of their clients' stock portfolios efficiently in order to avoid financial loss events for the brokerage. For the stock exchange side, they need to be prepared to manage a default process and mitigate systemic risk. Another challenge for the stock exchange is to control credit, market, liquidity and cash flow risk that this event may cause due to the closeout of large stock portfolios or brokerage, in order to generate capital efficiency for the market. To solve these issues, one embodiment employs a machine learning approach that identifies different stock portfolios closeouts strategies, to mitigate possible financial losses, and choose the most suitable machine learning model for the combination of variables available and generate the closeout order for the brokerage or even to a stock exchange.

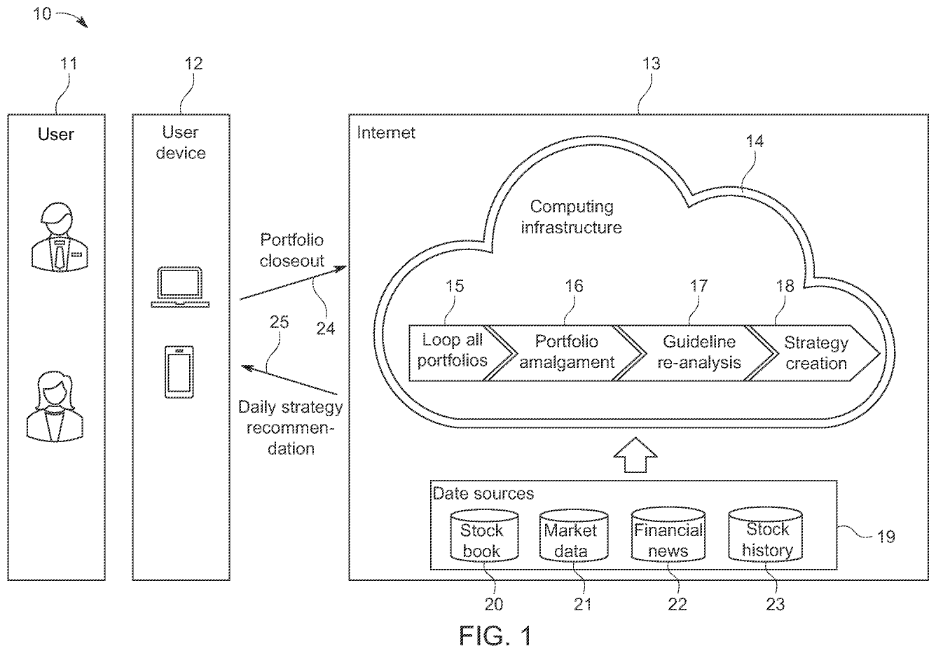

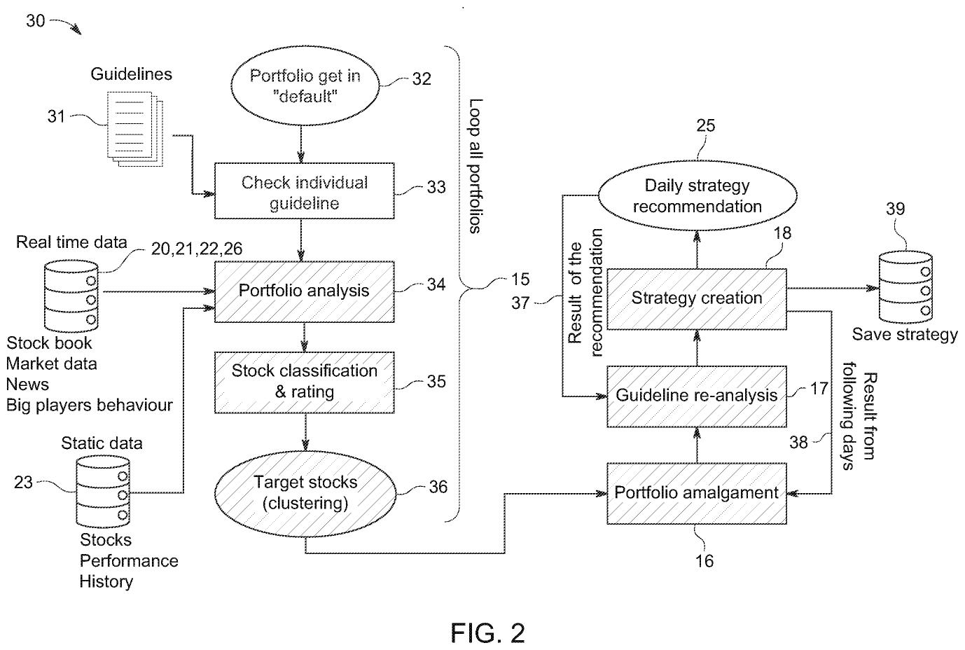

FIG. 1 illustrates an architecture 10 for using machine learning for optimization of multiple stock portfolios closeout, according to one embodiment. In one embodiment, a user 11 refers to a person that desires strategic recommendations to execute a stock portfolio closeout. The user device 12 refers to a computing device that a user 11 directly interacts with, which may be a laptop, desktop, mobile device, etc. In some embodiments, the user device 12 may be omnichannel. In one embodiment, the computing infrastructure 14 is a group of computing resources (loop all portfolios resource 15, portfolio amalgamate resource 16, guideline re-analysis 17 resource and strategy creation resource 18) that host the solution and executes the data gathering and prediction components. The Internet 13 is a vast network that connects computers all over the world. Through the Internet 13, people may share information and communicate from anywhere with an Internet connection. The Internet 13 enables communication among user devices 12, external sources and the solution core. In one embodiment, portfolio closeout information 24 is communicated from the user device 12 over the Internet 13 to the computing infrastructure 14. In one embodiment, daily strategy recommendation information 25 is communicated to the user device 12 over the Internet 13 from the computing infrastructure 14. The loop all portfolios resource 15 is a machine learning model that analyzes the guidelines 31 (FIG. 2) of each portfolio in default along with financial news 22 and economic scenario to classify and group the stocks based on volatility, stability, segment type, volume, etc.

In one embodiment, the portfolio amalgamate resource 16 is a machine learning model that combines the results of the loop all portfolios resource 15 to process all clients in default and generate a correlation graph to identify clients in worst situation and stocks to be acted upon on the shortest time. Guideline re-analysis resource 17 provides analyzing processing of the guidelines 31 (FIG. 2) of all clients in default to feed the system with a complete view of the constraints, limitations and imperatives. Strategy creation resource 18 is a machine learning model used for creating and recommending a liquidation stock strategy aiming to minimize financial loss.

In one embodiment, data sources 19 includes private or public customer information that may be retrieved by the system to enrich the existing client data. In one example embodiment, the data sources 19 include, but are not limited to: stock book 20, market data 21, financial news 22 and stock history 23.

In one or more embodiments, the machine learning models or algorithms utilized employ one or more artificial intelligence (AI) models or algorithms. AI models may include a trained machine learning model (e.g., models, such as an NN, a CNN, a recurrent NN (RNN), a Long short-term memory (LSTM) based NN, gate recurrent unit (GRU) based RNN, tree-based CNN, KNN, a self-attention network (e.g., a NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

FIG. 2 illustrates a flow processing diagram 30 for using machine learning for optimization of multiple stock portfolios closeout, according to one embodiment. In one embodiment, a portfolio 32 is the portfolio obtained from a user that gets the portfolio in default. This means that the client bought stocks to pay for in advance, but on the day of payment the client does not have the money, so client goes in default. The client's portfolio needs to be sold in order to minimize the broker loss. In one embodiment, the check individual guideline processing 33, for each client the broker has a guideline 31 that provides the rules to seal his/her portfolio in case of default. The guideline 31 includes a set of rules that optimize the worst scenario in case a user goes to a default, or for example, stock X can be sold only in 100 units (e.g., shares, notes, etc.) per day. For Client A that has 1000 units of Stock X it will take 10 days to sell all 1000 units of the Stock X.

In one embodiment, the portfolio analysis processing 34 provides that with the rules from guideline 31 the scenario is chosen based on the predictions of the market and other data, such as stock book 20, market data 21, news 22, big players behavior 26, economic scenario and the size of user portfolio. Additionally static data 23 including stocks, historical performance information, and risk assessment or grade is also provided to the portfolio analysis processing 34. For the stocks classification and rating processing 35, the stocks are classified based on their characteristics as volatility, stability, volume, segment type, etc. It should be noted that a stock may have more than one classification. In the target stocks (clustering) processing 36, the stocks are grouped based on their classification. The processing from the check individual guideline processing 33 to the target stocks (clustering) processing 36 are repeated in loop 15 for all portfolios.

In one embodiment, after the previous processing are performed for each client that are in default, the portfolio amalgamate processing 16 groups all the portfolios from all the clients since one client portfolio may interfere in another. The portfolio amalgamate processing 16 generates a graph of correlation among stocks and users. The generated graph shows users that are in more complicated situations, shows stocks that are in a large volume to be sold in a short time period, and also shows the guideline for each user. The portfolio amalgamate processing 16 also receives the results from other days or periods from previous clients in default.

In one embodiment, with the information from the portfolio amalgamate processing 16, in the guideline re-analysis processing 17 a machine learning processing model is utilized to create and recommend a strategy to sell the stock for that day in order to minimize the loss. To do that some methods may be used, such as a neural network, that is trained (re-trained) and used for a short time, for example the machine learning model may be trained with ten (10) minutes worth of data and used in the next ten (10) minutes or for a reinforcement learning for that.

In one embodiment, for the strategy creation processing 18, the strategy is created for the day and sent to be executed in an automatic system (or to a person for manual execution), and all the strategy information that is previously calculated is saved in storage (e.g., a database, etc.) 39 and grouped for the next day. In one embodiment, the daily strategy recommendation processing 25 provides that the strategy for the day is recommended to be executed. The result of the recommendation processing 37 is provided to the guideline re-analysis processing 17, and whether the recommendation was a good or a bad decision is used to develop (re-train) the model as a feedback. In one embodiment, the result from the following days 38 is fed back into the portfolio amalgamate processing 16.

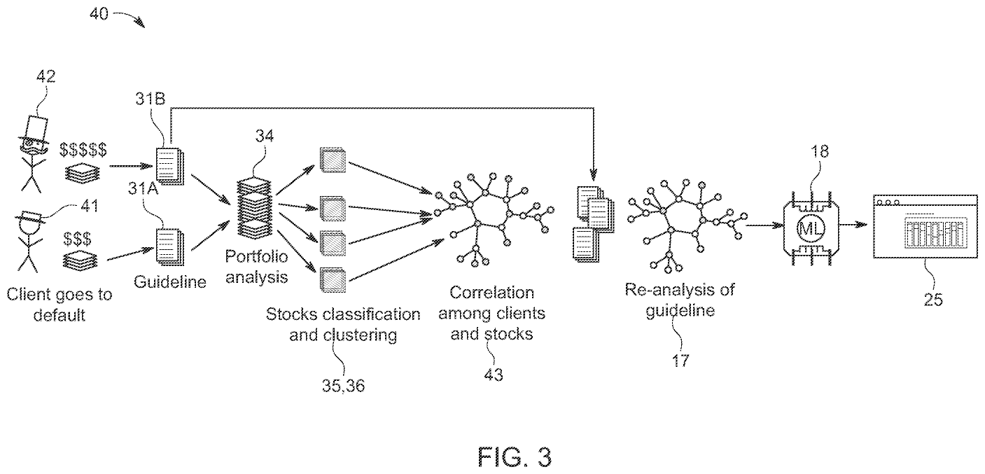

FIG. 3 illustrates an example embodiment system 40 for using machine learning for optimization of multiple stock portfolios closeout, according to one embodiment. In system 40, users 41 and 42 each have portfolios with user 41 going to default. The user 42 has a guideline 31B and the user 41 has the guideline 31A. Portfolio analysis processing 34 is performed based on both guidelines 31A and 31B. After the portfolio analysis processing 34, the results are provided for stock classification processing 35 and clustering processing 36. The results from the stock classification processing 35 and the clustering processing 36 are used for correlation among clients and stocks processing 43. The guideline 31A and 31B are used for the re-analysis of guideline processing 17 uses a machine learning processing model to create and recommend a strategy to sell the stock for that day in order to minimize the loss using the daily strategy recommendation processing 25, where the strategy for the day is recommended to be executed.

In one embodiment, the system 40 creates an artificial intelligent mechanism that optimizes multiple stock portfolios closeout by analyzing and operating on all portfolios in default instead of working on them individually. By acting on a group, the financial institution may reduce the loss during the portfolio closeout and identify a better and optimized strategy for stock operations. To closeout a portfolio of stocks, the financial institutions follow a procedure that can be either manual or automated, but in either case the procedure is unique to each client. By combining the portfolios in default, the financial institution not only optimizes the operation, but also expands its vision of the financial scenario, which can lead to better planning. One or more embodiments are configured to analyze individual portfolios in default, extract their guidelines, classify and rate the stocks, combine the portfolios, re-analyze the group guidelines, create an execution plan for the stocks and re-run the machine learning model in case of changes in the financial market.

In one or more embodiments, a machine learning creates and recommends a strategy to sell the stocks from the combined portfolios to minimize loss. Despite creating a sell plan for the day, the plan is not definitive. In case of rapid changes in the market where the defined thresholds are reached, another plan is generated in accordance with the new scenario. Therefore, distinguishable from conventional methods, instead of looking at the individual stock portfolio to sell off, the embodiments take into consideration all other portfolios that the financial institution has in custody and need to be closed out, combining their restrictions, directives and market risks to generate an execution strategy using a machine learning model to minimize the financial loss or even provide revenue to the financial institute.

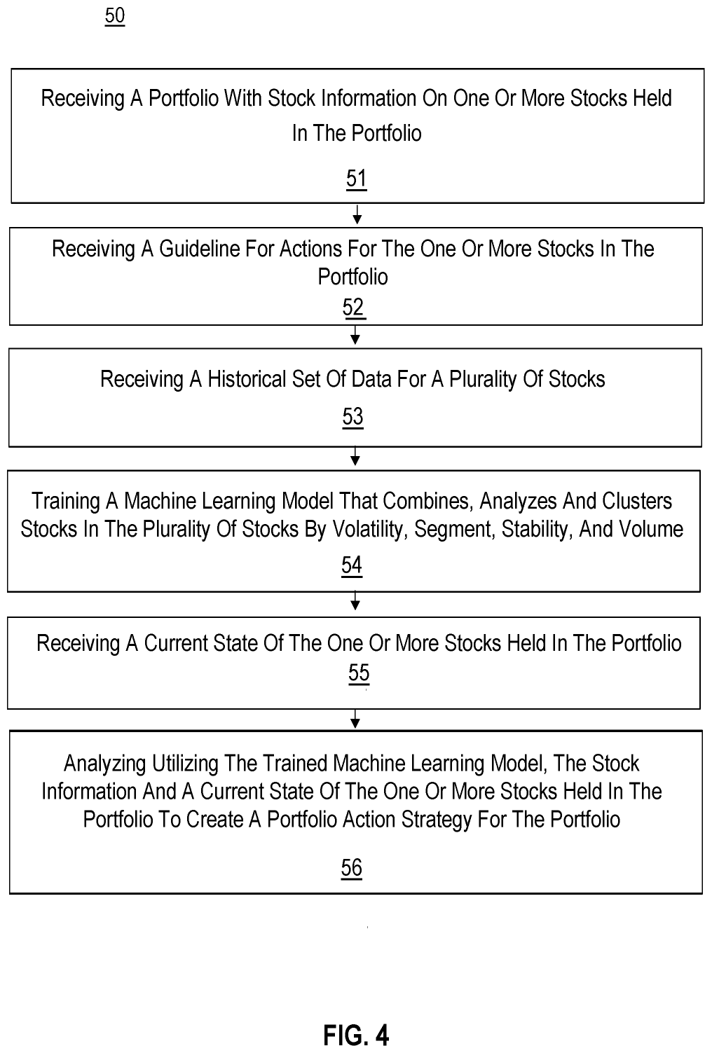

FIG. 4 illustrates a process 50 for using a computing device to provide AI-based optimization of multiple stock portfolios closeout, according to an embodiment. In one embodiment, in block 51 process 50 receives, by the computing device, a portfolio with stock information on one or more stocks held in the portfolio. In block 52, process 50 receives, by the computing device, a guideline for actions for the one or more stocks in the portfolio. In block 53, process 50 receives, by the computing device, a historical set of data for multiple stocks. In block 54, process 50 trains, by the computing device, a machine learning model that combines, analyzes and clusters stocks in the multiple stocks by volatility, segment, stability, and volume. In block 55, process 50 receives, by the computing device, a current state of the one or more stocks held in the portfolio. In block 56, process 50 analyzes, by the computing device, utilizing the trained machine learning model, the stock information and a current state of the one or more stocks held in the portfolio to create a portfolio action strategy for the portfolio.

In some embodiments, process 50 may include the feature where the machine learning model generates a graph for the portfolio action strategy.

In one or more embodiments, process 50 may further include the feature that the stock information comprises date purchased, amount of stock held, and type of stock shares.

In some embodiments, process 50 may include the feature where the guideline includes an outcome for achievement and one or more rules for implementation of actions.

In one or more embodiments, process 50 may additionally include the feature that the current state comprises current price, current transactional volume, and current volatility index.

In some embodiments, process 50 may further include the feature that the portfolio action strategy is created for a day and sent for execution in an automatic system.

In one or more embodiments, process 50 may include the feature that the machine learning model is re-trained using results of the portfolio action strategy as feedback to improve the machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

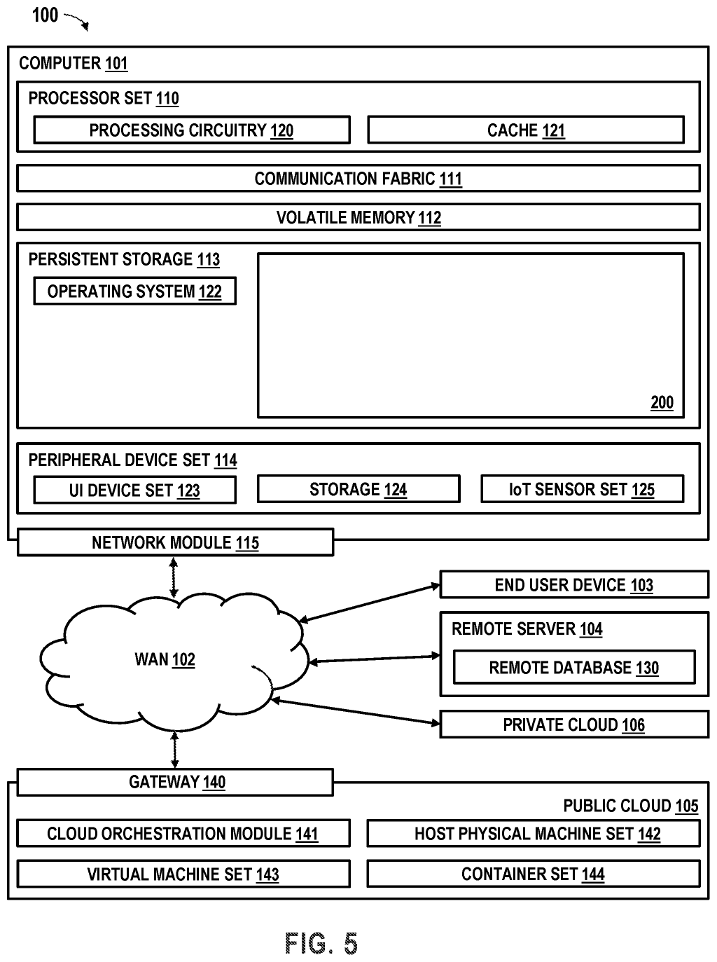

FIG. 5 illustrates an example computing environment 100 utilized by one or more embodiments. Computing environment 100 contains an example of an environment for the execution of at least some of the computer code 200 involved in performing the inventive methods (such as machine learning model code for optimization of multiple stock portfolios closeout, machine learning code for analyzing and generating a portfolio action strategy for clients, etc.). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to analyze and generate a portfolio action strategy for clients, the method comprising:
receiving, by the computing device, a portfolio with stock information on one or more stocks held in the portfolio;
receiving, by the computing device, a guideline for actions for the one or more stocks in the portfolio;
receiving, by the computing device, a historical set of data for a plurality of stocks;
training, by the computing device, a machine learning model that combines, analyzes and clusters stocks in the plurality of stocks by volatility, segment, stability, and volume;
receiving, by the computing device, a current state of the one or more stocks held in the portfolio; and
analyzing, by the computing device, utilizing the trained machine learning model, the stock information and a current state of the one or more stocks held in the portfolio to create a portfolio action strategy for the portfolio.

2. The method of claim 1, wherein the machine learning model generates a graph for the portfolio action strategy.

3. The method of claim 1, wherein the stock information comprises date purchased, amount of stock held, and type of stock shares.

4. The method of claim 1, wherein the guideline includes an outcome for achievement and one or more rules for implementation of actions.

5. The method of claim 1, wherein the current state comprises current price, current transactional volume, and current volatility index.

6. The method of claim 1, wherein the portfolio action strategy is created for a day and sent for execution in an automatic system.

7. The method of claim 1, wherein the machine learning model is re-trained using results of the portfolio action strategy as feedback to improve the machine learning model.

8. A computer program product for analyzing and generation of a portfolio action strategy for clients, the computer program product comprising a computer readable storage medium having program instructions embodied therewith, the program instructions executable by a processor to cause the processor to:
receive, by the processor, a portfolio with stock information on one or more stocks held in the portfolio;
receive, by the processor, a guideline for actions for the one or more stocks in the portfolio;
receive, by the processor, a historical set of data for a plurality of stocks;
train, by the processor, a machine learning model that combines, analyzes and clusters stocks in the plurality of stocks by volatility, segment, stability, and volume;
receive, by the processor, a current state of the one or more stocks held in the portfolio; and
analyze, by the processor, utilizing the trained machine learning model, the stock information and a current state of the one or more stocks held in the portfolio to create a portfolio action strategy for the portfolio.

9. The computer program product of claim 8, wherein the machine learning model generates a graph for the portfolio action strategy.

10. The computer program product of claim 8, wherein the stock information comprises date purchased, amount of stock held, and type of stock shares.

11. The computer program product of claim 8, wherein the guideline includes an outcome for achievement and one or more rules for implementation of actions.

12. The computer program product of claim 8, wherein the current state comprises current price, current transactional volume, and current volatility index.

13. The computer program product of claim 8, wherein the portfolio action strategy is created for a day and sent for execution in an automatic system.

14. The computer program product of claim 8, wherein the machine learning model is re-trained using results of the portfolio action strategy as feedback to improve the machine learning model.

15. An apparatus comprising:
a memory configured to store instructions; and
a processor configured to execute the instructions to:
receive, by the processor, a portfolio with stock information on one or more stocks held in the portfolio;
receive a guideline for actions for the one or more stocks in the portfolio;
receive a historical set of data for a plurality of stocks;
train a machine learning model that combines, analyzes and clusters stocks in the plurality of stocks by volatility, segment, stability, and volume;
receive a current state of the one or more stocks held in the portfolio; and
analyze utilizing the trained machine learning model, the stock information and a current state of the one or more stocks held in the portfolio to create a portfolio action strategy for the portfolio.

16. The apparatus of claim 15, wherein the machine learning model generates a graph for the portfolio action strategy.

17. The apparatus of claim 15, wherein the stock information comprises date purchased, amount of stock held, and type of stock shares.

18. The apparatus of claim 15, wherein the guideline includes an outcome for achievement and one or more rules for implementation of actions.

19. The apparatus of claim 15, wherein the current state comprises current price, current transactional volume, and current volatility index.

20. The apparatus of claim 15, wherein:
the portfolio action strategy is created for a day and sent for execution in an automatic system; and
the machine learning model is re-trained using results of the portfolio action strategy as feedback to improve the machine learning model.
